(19) United States
(12) Patent Application Publication
(10) Pub. No.: US 2023/0078386 A1
(43) Pub. Date: Mar. 16, 2023

(54) SYSTEM AND METHOD FOR MONITORING AND CONTROLLING A BANDSAW BLADE

(71) Applicant: Tolko Industries Ltd., Vernon (CA)

(72) Inventors: Brett Martin Erickson, High Level (CA); Alexander James Meikle, High Level (CA); Peter Fehr, High Level (CA); Peter Wolfe, High Level (CA)

(21) Appl. No.: 17/944,581

(22) Filed: Sep. 14, 2022

Related U.S. Application Data
(60) Provisional application No. 63/244,225, filed on Sep. 14, 2021.

(51) Int. Cl. B23D 59/00; B23Q 17/09

(52) U.S. Cl. CPC B23D 59/002; B23Q 17/0914

(57) ABSTRACT

A system and method for monitoring and controlling the position of a bandsaw blade of a cutting machine used in sawmills are provided. The system comprises a light source, an imaging device and a processing structure for processing images captured by the imaging device and controlling the adjustment of the position of the bandsaw blade. The light source projects diffused light on a first side of the bandsaw blade through a diffuser member and the imaging device looks at a second side of the bandsaw blade. Each image captured by the imaging device shows a boundary line between a light area and a dark area, which represents the position of the cutting edge of the bandsaw blade. The position of the bandsaw blade then can be monitored and controlled for adjustment to its ideal position based on the measurement of the boundary line.

### FIELD

This invention generally relates to systems and methods for monitoring and controlling positions of a bandsaw blade used in a cutting machine or a band mill in a sawmill for cutting/milling logs, as well as for monitoring the health of a bandsaw during operation.

### BACKGROUND

Various cutting machines have been widely used in the sawmill industry for cutting logs to produce lumber. One conventional type among these cutting machines can be a band mill comprising an endless bandsaw blade driven by a pair of wheels. The working position or location of the bandsaw blade is very important for proper cutting and maintaining bandsaw life. A detecting system may be used to monitor the position of the bandsaw blade. Adjustment to the position of the bandsaw is needed when the bandsaw blade is out of the proper working position.

However, the prior detecting technique may involve reflected light to measure the position of the bandsaw blade. One problem of using reflected light is that the accuracy of the measurement of the saw blade may be affected by the angle of the bandsaw blade itself and the position of the bandsaw blade relative to the camera. The changes of the angle of the bandsaw blade itself and the relative position of the camera to the bandsaw blade will cause the reflected angle of the light towards the camera to change, which results in inaccurate measurements from the images of the camera.

Other known prior systems, such as those using inductive proximity sensors, may also have the inaccuracy problem that affects the quality of cutting. It is therefore desirable to develop or improve systems and methods that provide accurate measurements for monitoring and controlling a bandsaw blade of a cutting machine.

### SUMMARY

According to one aspect, a system for monitoring and controlling positions of a bandsaw blade used in a cutting machine in a sawmill is provided. The bandsaw blade has a first side, a second side and a cutting edge. The monitoring system comprises a light source and an imaging. The light source projects light on the first side of the bandsaw blade. The imaging device looks at the second side of the bandsaw blade and captures images of the bandsaw blade under the back light of the light source. A processing structure receives and processes the images captured by the imaging device to determine a position of the cutting edge.

In one aspect, the light source further comprises a diffusing member such as a strip of ultra high molecular weight polyethylene (UHMW) plastic placed in front of the light source to diffuse the light from the light source.

In one aspect, the processing structure may be configured to measure a position of a boundary line between a light area and a dark area of each image to determine the position of the cutting edge of the bandsaw blade.

In a further aspect, the processing structure may comprise instructions to define an electronic movable ruler represented by a bounding box having a center location, an upper edge and a lower edge.

In one aspect, the processing structure may be configured to determine the position of the cutting edge of the bandsaw blade by measurement of a value along an X coordinate of the center location when the center location of the bounding box aligns with the center of the boundary line.

In another aspect, the processing structure may be configured to determine the position of the cutting edge of the bandsaw blade by measurement of a value along an X coordinate of the center location when the upper edge and the lower edge of the bounding box align with an upper edge and a lower edge of the light area of each image, respectively.

According to a further aspect of the invention, a cutting machine including a monitoring system as described above for monitoring and controlling the bandsaw blade comprises a drive wheel; an idle wheel; and a tilt assembly engaging with the shaft of the idle wheel. The bandsaw blade is mounted around the drive wheel and the idle wheel. The drive wheel is driven by hydraulics to first apply tension to the bandsaw blade. The tensioned bandsaw blade then works as a transmission mechanism to transmit power from the drive wheel to the idle wheel, and then causes the bandsaw blade continuously move when the drive wheel and the idle wheel rotate. The monitoring system monitors the position of the bandsaw blade while the bandsaw blade is running. A controller may control the tilt assembly to move the shaft of the idle wheel thereby to adjust the position of the bandsaw blade.

Upon measurements to the position of a boundary line between a light area and dark area from each image, the position of the bandsaw blade is determined. The tilt assembly may be controlled by a controller or a PLC to move based on the measurements for automatically adjusting the position of the bandsaw blade when the position of the bandsaw blade is off its proper working position.

In another aspect, the cutting machine may comprise a console connected with the controller. The console may include buttons such as forward/reverse button to activate an electric motor to drive the tilt means to cause the shaft of the idle wheel to move.

According to another aspect, a method for monitoring and controlling the bandsaw blade of a cutting machine is provided. The method comprises projecting light on a first side of the bandsaw blade; capturing at least one image of a second side of the bandsaw blade; measuring a position of a boundary line between a light area and a dark area of each image of the at least one image; determining a position of the bandsaw blade based on the position of the boundary line; and adjusting the position of the bandsaw blade when the bandsaw blade deviates from its standard working position.

According to a further aspect, the boundary line is generated when the exposure time of the imaging device is sufficiently long relative to the speed of the bandsaw while the bandsaw is running to make the teeth of the bandsaw blade not visible. The light alternates between being blocked by the teeth of the bandsaw blade, and passes through a gullet between each of the teeth of the bandsaw blade. Increasing the exposure time of the imaging device may filter out the teeth, and create the boundary line between the backlight and the bandsaw blade shadow, which represents the location of the bottom of the gullet.

According to another aspect, the method may comprise defining a bounding box before measuring the position of the boundary line. The bounding box has a center location, an upper edge and a lower edge.

In another aspect, the step of measuring the position of the boundary line may comprise measuring a location of the X when the center location of the bounding box aligns with the center of the boundary line.

In another aspect, the step of measuring the position of the boundary line may comprise measuring the location of the X when the upper edge and the lower edge of the bounding box align with an upper edge and a lower edge of the light area of each image respectively.

According to another further aspect, a method for determining the oscillation of the bandsaw blade is provided by monitoring the position of the bandsaw blade on the wheel as the bandsaw blade is moving. When the oscillation of the bandsaw blade increases more than an allowable amount, an indication or warning is provided. The cutting machine may be stopped before the blade fails.

According to a further aspect, a standard deviation of the blade can be used to measure the oscillations. The standard deviation of the position of the bandsaw blade over time increases when cracks form on the bandsaw blade. Monitoring the standard deviation of the bandsaw blade's shift by this monitoring system also allows for detection of cracks and other imbalances that may inevitably lead to catastrophic failure of the band if not addressed soon enough. This method can avoid the bandsaw blade failure and the associated downtime and safety risks by removing the bandsaw from the wheel and possibly fixing it before it fails and becomes scrap.

According to another aspect, an initial standard deviation of the position of the bandsaw blade is determined from a plurality of images as the bandsaw blade is moving. The standard deviation of the position of the bandsaw blade is continued to be determined and monitored. When the standard deviation of the position of the bandsaw blade increases more than an allowable value from the initial standard deviation, the indication or warning, such as in the form of light or sound, is provided. The cutting machine may be stopped. The blade may be removed and replaced with a new one before it fails.

### DESCRIPTION OF THE DRAWINGS

While the invention is claimed in the concluding portions hereof, example embodiments are provided in the accompanying detailed description which may be best understood in conjunction with the accompanying diagrams:

FIG. 1 is a schematic view of a cutting machine and system for monitoring a bandsaw blade of the cutting machine;

FIG. 2 is a cross-sectional view along A-A of FIG. 1;

FIG. 3 is an enlarged view of a portion I, shown in FIG. 2;

FIG. 4 is an enlarged cross-sectional view of a portion of the system for monitoring the bandsaw blade;

FIG. 5 is a flow chart of monitor process for measuring and adjusting the position of the bandsaw blade;

FIG. 6 is an image of the bandsaw blade while running;

FIG. 7 is a diagram showing connections of a PLC with other components; and

FIG. 8 a schematic view of a cutting machine and system for monitoring a bandsaw blade according to another aspect.

### DETAILED DESCRIPTION

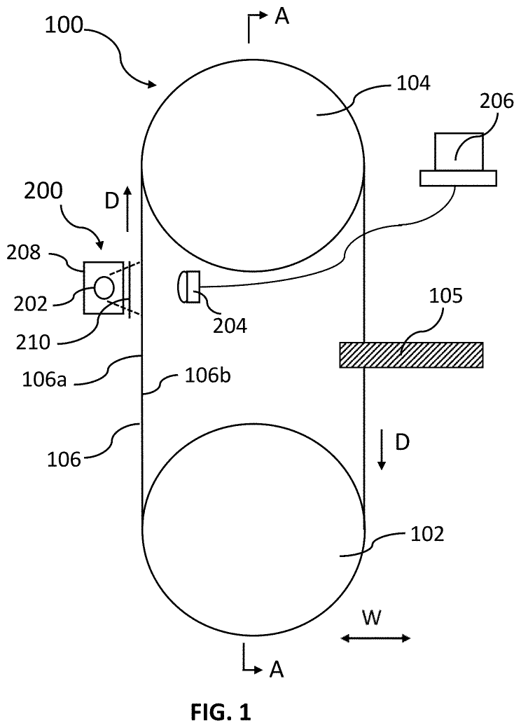

FIG. 1 shows a cutting machine 100 or a band mill used in a sawmill for cutting logs, and a monitoring system 200 for monitoring a blade 106 of the cutting machine 100. The cutting machine 100 may have a supporting frame supporting a pair of wheels 102, 104 in a spaced relationship to each other. A drive wheel 102 and an idle wheel 104 may each be rotatably coupled to the supporting frame. An endless bandsaw blade 106 may be held in position around the pair of the wheels 102 and 104 using tension.

The drive wheel 102 may be driven by a power source, such as a motor, to rotate thereby imparting rotation of the blade 106 around the pair of wheels 102, 104. A vertical distance between the drive wheel 102 and the idle wheel 104 may increase or decrease depending on the sawing application. In this aspect, the bottom drive wheel 102 is driven by an electric motor to apply motion to the blade 106. The idle wheel 104 may be adjusted to increase or decrease the vertical distance between the drive wheel 102 and the idle wheel 104 thereby increasing or decreasing tension on the blade 106. Once the bandsaw blade 106 is tensioned, the tensioned blade 106 may work as a transmission mechanism to transmit power from the drive wheel 102 to the idle wheel 104 due to the tension, and then causes rotation of the idle wheel 102. In this way, the idle wheel 104 may be driven to rotate simultaneously with the drive wheel 102 to cause the blade 106 to continuously move, for example, along a direction D. In this aspect, the blade 106 may move at a speed around 10,000 SFPM (surface feet/min). A log is able to be cut at a proper position by the blade 106 to obtain one or more boards of wood.

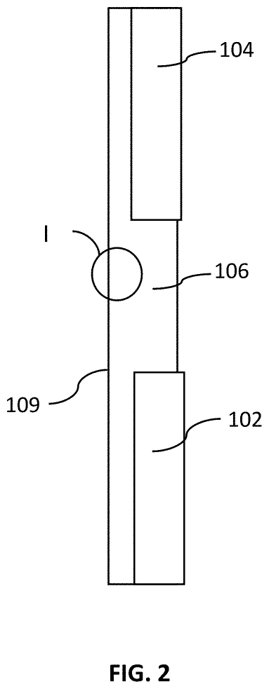

In order to achieve accurate cutting and/or to prevent premature wear of the blade 106, a position of the blade 106 may be properly located. One or more teeth of the blade 106 and a small portion of the bandsaw blade 106 may stick out over the wheels 102, 104 as shown particularly in FIG. 2. When the blade 106 sticks out too far from the wheels 102, 104, the blade 106 may not be supported and/or may bend with time. In severe circumstances, a bending angle of the blade 106 may result in extreme cutting deviation and/or the blade 106 may be pulled off one or more of the wheels 102, 104. When the blade 106 is too far back (e.g. recessed), the teeth 107 may cut other components of the machine, such as a blade guide (not shown) that supports the blade 106 above the log being cut.

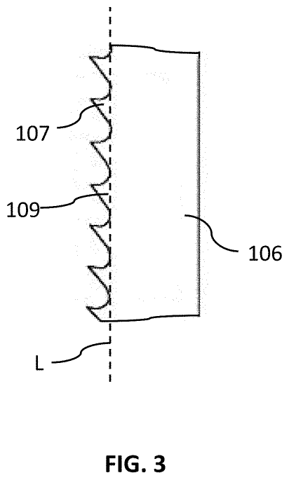

FIG. 3 shows a portion of the blade 106 with bottoms of the teeth 107 forming a saw edge or cutting edge 109 presented by a dotted line L, which is also referred to as position of the blade 106.

In another aspect, the cutting machine 100 may further comprise a tilt assembly to engage with one side of the shaft of the idle wheel 104. For example, the tilt assembly may simply be a worm-gear box driven by an electric motor. The output of the gearbox may cause the one side of the shaft of the top idle wheel 104 to be higher or lower to the other side of the draft so that the blade 106 on the idle wheel 104 may be automatically moved or shifted meanwhile the driven wheel 102 may be kept still. In this way, the blade 106 may be adjusted to an ideal position.

In another aspect, the cutting machine 100 may further comprise a carriage driven by a hydraulic cylinder. The cartridge may be in the form of a sliding frame that holds and supports most components of the cutting machine 100 such as the drive and idle wheels, the tilt assembly, and a bandsaw blade monitoring system. The carriage moves to cut log pieces to different widths, and the cartridge may simply try to always maintain the location. During operation, before performing the cutting, the carriage may be driven by a hydraulic cylinder such as along the direction W shown in FIG. 1 to move along a guide towards and/or from a center place where a log 105 is located for cutting so that both the driven wheel 102 and the idle wheel 104 are moved simultaneously. The blade 106 on the driven wheel 102 and the idle wheel 104 are therefore moved accordingly to adjust the position of the blade 106. The direction W may be perpendicular to the bandsaw moving direction D, and parallel to the path of the log 105 through the blade 106. The position of the blade 106 along this direction W may also be referred to as a perpendicular position.

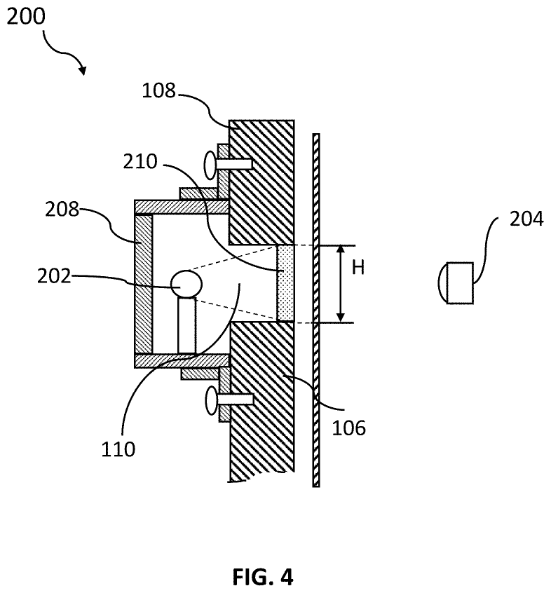

A blade monitoring system 200 may continuously monitor the position of the blade 106. According to one aspect, the monitoring system 200 comprises a light source 202, an imaging device 204, such as a camera, and a processing unit 206 such as a computer for processing one or more images from the imaging device 204. The processing unit 206 may control the adjustment of the position of the blade 106. In this aspect, the imaging device 204 may be mounted on the frame of the carriage above the drive wheel 102 so that the position of the imaging device 204 relative to the blade 106 may be fixed, because the imaging device 204 moves with the carriage that supports the drive and idles wheels 102 and 104 that hold the blade 106. The light source 202 may be located on an exterior or a first side 106a of the blade 106. The imaging device 204 may have a field of view of an internal side or a second side 106b of the blade 106. The light source 202 may be on an opposite side of the blade 106 relative to the imaging device 204. In other words, the light source 202 may project light on an external side or the first side 106a of the blade 106 and the imaging device 204 captures images of the internal side or the second side 106b of the blade 106 such that the light source 202 may provide a backlight for the blade 106. FIG. 4 shows details of an example of the monitoring system 200.

In one aspect, the monitoring system 200 may further comprise a light diffusing member 210 that diffuses light that passes through it, such as a strip of ultra-high-molecular weight (UHMW) plastic that is transparent with a frosted or coated surface to diffuse light that passes through the light diffusing member 210. The light diffusing member 210 can be placed in front of the light source 202 so that illumination from the light source 202 passes through the light diffusing member 210 onto the first side 106a of the blade 106. This light diffusing member 210 can diffuse light from the light source 202 so that the diffused light generates a glowing effect that ensures even light distribution from all angles on the bandsaw blade 106. In some aspects, the diffusing member 210 may protect the light source from the environment.

The light diffusing member 210 can be positioned so that part of the light diffusing member 210 will extend behind the blade 106, from the point of view of the imaging device 204, and part of the light diffusing member 210 extends the other way past the cutting edge 109 of the blade 106, from the point of view of the imaging device 204. In this manner, an image taken by the imaging device 204 can include the light diffusing through the portion of the light diffusing member 210 that extends past the cutting edge 109 of the blade 106 and is unimpeded by the blade 106 and the blade 106 that will be dark because it is blocking light diffused through portion of the light diffusing member 210 behind the blade 106.

In another aspect, the light source 202 may be installed in a box or housing 208 with the diffusing member 210 being one of the sides of the box 208. The diffusing member 210 may abut an opening 110 in a guard 108. Alternatively, the diffusing member 210 may be installed in the opening 110 of the guard 108 as shown in FIG. 4. The box 208 may be mounted behind the guard 108 through which the bandsaw blade 106 passes with the opening 110 facing the guard 108. In this way, the light source 202 in the light box 208 behind the guard 108 illuminates the bandsaw blade 106 through the diffusing member 210 in the opening 110 of the guard 108.

Alternatively, the diffusing member 210 may be the front wall of the box 208. The whole box 208 may be installed behind the opening 110 of the guard 108.

Under the illumination of the diffused light on the first side 106a of the blade 106, the imaging device 204 may capture images of a shadow of the blade 106 on the second side 106b. The captured images may be transferred to the processing unit 206 for display and/or processing. The position of the blade 106 can then be determined by measuring the images of the blade 106. Because of the diffused light, the position of the cutting edge 109 of the blade 106 may be measured accurately regardless of an angle and/or a position of the blade 106 relative to the imaging device 204. Since the illumination of the diffused light provides the backlight to the blade 106, monitoring of the position of the blade 106 and/or the angle of the blade 106 may be computationally more efficient as any foreign material on the blade 106 may not be visible as the blade 106 is shown in shadow to the imaging device 204.

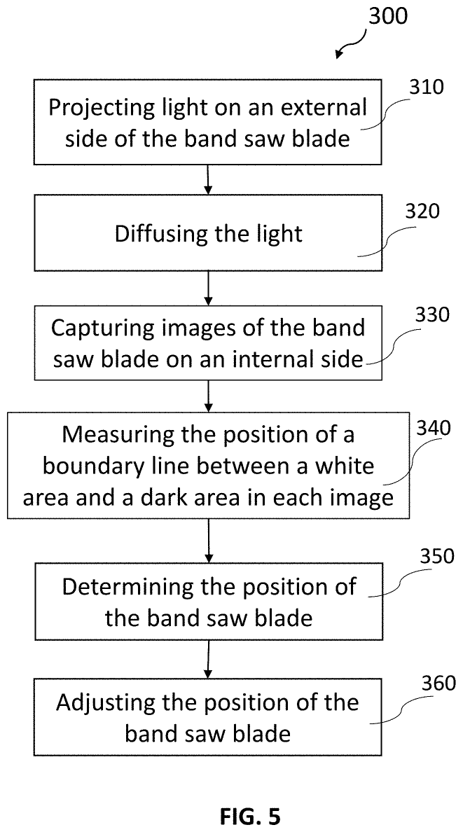

Details of the process for measuring or monitoring the blade 106 are illustrated with reference to the example process in flow chart 300 of FIG. 5. During operation, the light source 202 may project light on the first side 106a of the bandsaw blade 106 at step 310. The light may be further diffused by the diffuser member 210 for providing even distributed light at step 320. The imaging device 204 can then captures one or more images of the second side 106b of the blade 106 at step 330. In particular, when a new blade 106 is installed for the first time, the imaging device 204 may take a first calibration image. In an aspect, the imaging device 204 may be configured to automatically take images when the blade 106 starts running.

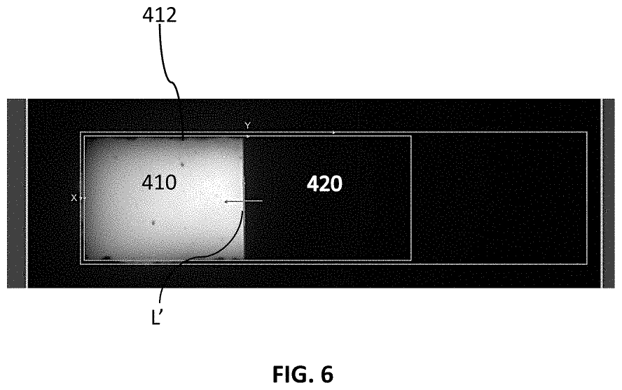

While the blade 106 is being rotated by the wheels 102, 104, the imaging device 204 may capture images of the blade 106 periodically or continuously in order to measure the position of the blade 106. For example, the images may be taken at a camera exposure time of 70-ms while the bandsaw blade 106 may be running at speed of 10,000 SFPM. Due to the exposure time of the camera being sufficiently long relative to the speed of the blade 106, the details (e.g. teeth) in the image may be filtered out due to blur, forming a continuous line L′ (as shown in FIG. 6) where the teeth 107 or a gullet between each of the teeth 107 is no longer visible. The position of the continuous line L′ in the images corresponds to the position of the cutting edge line L shown in FIG. 3. In other words, the continuous line L′ corresponds with the cutting edge 109 of the solid portion of the blade 106 that light cannot pass through. The teeth may disappear in the image.

FIG. 6 shows an example image of a portion of the blade 106 taken by an imaging device 204, in this case a greyscale camera. A binary filter may be applied to the greyscale camera. A dark area 420 on the right side of the image is the place where the light from the light source 202 is blocked by the blade 106 while a light area 410 on the left side of the image is where light from the light source 202 passing through the light diffusing member 210 reaches the imaging device 204 because it is unimpeded by the blade 106 and instead shines around the blade 106. With a long enough exposure of the image taken by the image device 204, the teeth 107 of the blade 106 will be in the light area 410, because the long exposure will allow the light behind the teeth 107 to appear in the image as the teeth 107 pass through the image area.

If a light diffusing member 210 is used to diffuse the light from the light source 102, the light area 410 can be the portion of the light diffusing member 210 that is not covered by the blade 106 and the dark area 420 can be the portion of the light diffusing member 210 that is covered by the blade 106.

A boundary line L′ between the light area 410 and the dark area 420 represents the position of the cutting edge 109 of the blade 106.

In another aspect, the imaging device 204 may be a RGB camera or a camera sensitive to a specific wavelength of light, such as an infra-red camera. The light source 202 may be configured with the specific wavelength corresponding to the wavelength of a filter to block all other wavelength of light.

In one aspect, an image processing program executing on the processing unit 206 or onboard of the imaging device 204 may define an electronic movable ruler represented by a bounding box 412 as shown in FIG. 6. The bounding box 412 has a center position marked by X and Y. The ruler may be moved to the position of the image with the center position aligning with the center of the boundary line L′. In this way, the X, Y coordinate of the center of the boundary line L′ can be measured at step 340. The position of the cutting edge 109 of the blade 106 can be determined from the measurement of the value along the X coordinate of the center location of the bounding box, namely an X-axis location in the image at step 350.

According to another aspect, a height of the bounding box 412 may correspond to the height of the light area 410. This height of the light area 410 may be determined by the height of the opening 110 that limits the light from the light source 202 to a height H on the blade 106, shown in FIG. 4. Therefore, an upper edge and a lower edge of the bounding box may be aligned with the upper edge and the lower edge of the light area 410. This configuration allows for a more computationally efficient alignment than the method of aligning the center of the bounding box 412 with the center of the light area and makes easier to determine the X-axis location, which is the position of the cutting edge 109 of the blade 106. Using upper edge and the lower edge of the bounding box 412 as a reference make computationally efficient to detect and re-align the imaging device 204 if the imaging device 204 position or angle is inadvertently changed. In one aspect, an edge finding algorithm may be used to align edges of the bounding box 412 with the edges of light area 410 of the image. In addition, minimizing the size of the boundary box 412 decreases the processing time in CPU or the processing unit 206 required to find an image edge because there is a smaller, and more targeted window of image to be processed.

Based on the measurement, the position of the blade 106 may be controlled and adjusted by the processing unit 206 at step 360, such as via the blade tilt assembly. As described above, the tilt assembly in the cutting machine 100 may be driven by an electronic motor and engages with one side of the shaft of the idle wheel 104 to move this side of shaft higher or lower than the other side of the shaft. However, there may be many changes or modification to the tilt assembly as understood by those skilled in the art, such as using hydraulic power to tilt the shaft. All such suitable changes or modifications may not limit the claimed invention, and are intended to fall within the scope of the invention.

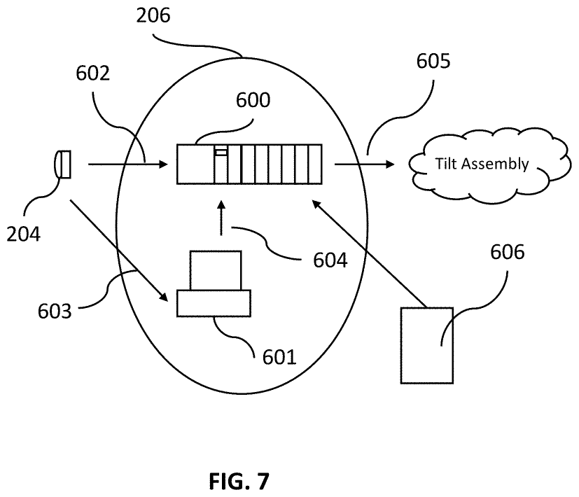

In one aspect, the cutting machine 100 may comprise a console connected to a controller such as a programmable logic controller (PLC) for controlling the tilt assembly. FIG. 7 shows an example of the connection of the PLC 600 and the console 606 with other components. The console 606 may be for manual movement of the tilt assembly and may comprise one or more buttons or may be implemented on a touch screen. For example, the console 606 may include a forward/reverse button to activate an electric motor to run forward (upstream) or reverse (downstream). The motor may cause the one side of the shaft of the idle wheel 104 to move up or down. In this aspect, the forward/reverse buttons may activate a variable frequency drive (VFD) and run the electric motor forward or reverse to achieve a desired tilting behavior. The processing unit 206 may comprise an image processing computer 601 connected with the imaging device 204. The raw image data may be sent to image processing computer 601 via connection 603 for off-board processing. The processing results from the image processing computer 601 may be sent to the PLC 600 via connection 604. If the raw camera image data have been processed on-board within the imaging device 204, the processing results from the imaging device 204 may be sent directly to the PLC 600 via connection 602. Operating the console 606 may control the tilt assembly to tilt the idle wheel 104 via the PLC 600 through connection 605 so that the position of the bandsaw blade 106 tensioned around the drive wheel 102 and the idle wheel 104 may be adjusted.

According to another aspect of the invention, the monitoring system 200 may also detect defects, such as cracking in the blade 106. Cracks usually occur perpendicular to the bandsaw blade edge along some pre-weakened lined in the bandsaw blade body. Ordinarily during use, the blade 106 can move backwards and forwards in the X-direction, or oscillate, rather than maintaining exactly the same position. As defects weaken or cracks form in the blade 106, these oscillations of the blade 106 can increase and continue to increase as the defects weaken further or the cracks increase in size. Eventually, if ignored, these defects or cracks can cause the blade 106, dangerously flying around in the cutting machine 100 and wrap around the equipment inside, and leading to catastrophic failure if not addressed soon enough.

In order to avoid these blade failures and the associated downtime and safety risks, the oscillation of the blade 106 may be measured and monitored. When the oscillation increases to a certain level, the movement of the blade 106 can be stopped and the blade 106 replaced with a new blade 106.

According to one aspect, the computer 601 may be configured to determine the oscillation of the blade 106 by monitoring the position of the blade 106, as the blade 106 is moving, and when the oscillation of the blade 106 increases more than an allowable amount, the cutting machine 100 can be stopped before the blade 106 fails. One way to measure these oscillations is to measure a standard deviation of the blade 106 as it moves back and forth because of the oscillations. The standard deviation of the blade 106 may be calculated from a number of positions of the blade 106 measured during a period of time, for example 100 or 150 images during 10 or 15 minutes, while the blade 106 is moving. For example, images such as the images shown in FIG. 6 can be taken showing the position of the boundary line L′ at a specific time. By taking images at time intervals and the position of the boundary line L′ in each of these images, the standard deviation of the position of the cutting edge 109 of the blade 106, or how much the blade 106 is moving back and forth from the oscillations can be determined.

When the oscillation of the blade 106 increases from enlarging of defects or cracks on the blade 106, the distance the blade 106 moves back and forth can also increase and therefore the measured standard deviation can increase. Monitoring the standard deviation of the position of the blade 106 may effectively detect the defects such as cracks and/or other imbalances that may inevitably lead to catastrophic failure allowing the cutting machine 100 to be stopped before the catastrophic failure occurs.

In one aspect, when a new blade 106 is installed, setup and aligned on the cutting machine 100, the cutting machine 100 can be started and the blade 106 begins to move. An initial standard deviation can be determined by monitoring the position of the blade 106 as it is moving for an initial period after the cutting machine 100 is first started with the new blade 106. This initial standard deviation may be calculated from a number of images over this initial period of time by the computer 601, such as 15 minutes. The initial standard deviation may vary from different works and may depend on the skills of the operators or the accuracy of the alignment.

As the blade 106 continues moving, images of the blade 106 can be repeatedly taken and the position of the blade 106 repeatedly determined to calculate the measured standard deviation of the blade 106 over time. As cracks form and grow in the blade 106, the measured standard deviation should become larger than the initial standard deviation. Once the measured standard deviation of the blade 106 increases more than an allowable amount over the initial standard deviation, the computer 601 may automatically generate an indication that this allowable amount has been surpassed. This indication could be warning, for example in the form of light or sound or even an automatic stopping of the cutting machine 100. The operator may then stop the operation of the cutting machine 100 and replace the blade 106.

In one aspect, this allowable amount could be 30% more the initial standard deviation.

According to a further aspect, as the initial standard deviation may vary depending on the skills of the person installing the blade 106, it may affect the decision to replace the blade. For instance, if the blade 106 is well aligned at the beginning and has little or no oscillation, the initial standard deviation may be close to 0 (running very straight instead of oscillating). Under this situation when a 30% increase over the initial standard deviation is used for the allowable amount, the allowable amount is so small that the allowable amount may be surpassed, long before the blade 106 is in danger of failing. Therefore, a threshold value can be with the allowable amount and the allowable amount can be the greater of the threshold value or the calculated amount. If the means of determining the allowable amount results in an allowable amount less than this threshold value, only when the shift of the position of the blade 106 is over this threshold value will the cutting blade 106 be stopped and the blade replaced. In one aspect, this threshold value could be 75 thousands of an inch.

The configuration as described herein may require minimal or no alignment of the imaging device 204 and the light source 202. Accurate measurements to the position of the blade 106 may be achieved.

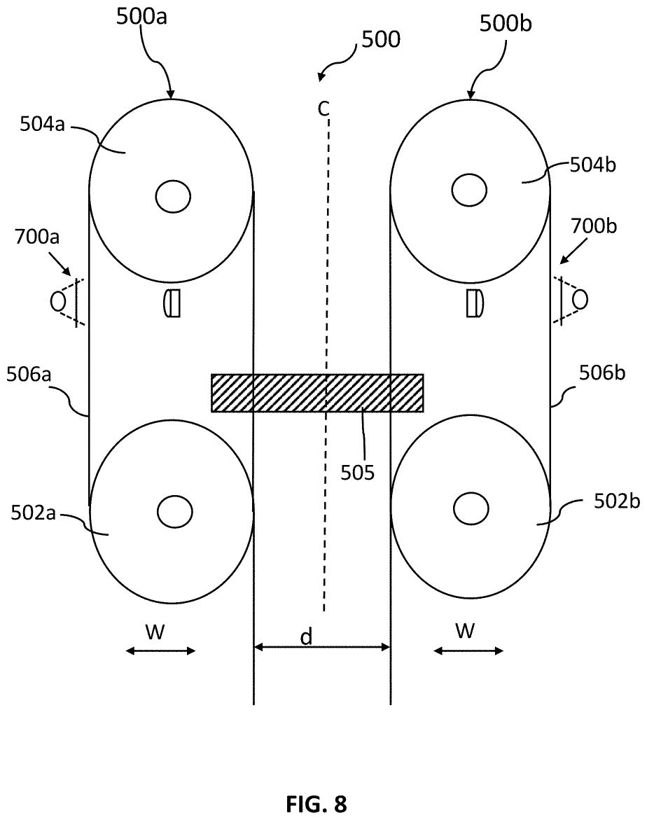

Now referring to FIG. 8, a cutting apparatus 500 according to another aspect is described. The cutting apparatus 500 may comprise two sets of the cutting machines 100, also referred to as a left cutting machine 500a and a right cutting machine 500b. In other words, the left cutting machine 500a comprises a left drive wheel 502a and a left idle wheel 504a, and the right cutting machine 500b comprises a right drive wheel 500b and a right idle wheel 504b. A left blade 506a runs around the left drive wheel 502a and the left idle wheel 504a. A right blade 506b runs around the right drive wheel 500b and the right idle wheel 504b. Each blade 506a, 506b may be monitored by a corresponding monitoring system 700a, 700b. Each monitoring system 700a, 700b comprises a light source projecting light on an external side of the corresponding blade and a imaging device, such as a camera, looking at an internal side of the corresponding blade as described above with reference to FIG. 1. Images taken by the imaging devices may be transferred to the processing unit 206 for processing so that the perpendicular positions of the blade 506a and 506b may be measured according the image processing method discussed above.

In one aspect, each cutting machine 500a and 500b may comprise a tilt assembly that engages with the shaft of the idle wheel 504a and 504b, respectively. For example a left tilt assembly may engage with the shaft of the left idle wheel 504a and a right tilt assembly may engage with the shaft of the right idle wheel 504b. The position of each blade can be adjusted by its corresponding tilt assembly. The image processing results processed by the processing unit 206 may be sent to a PLC to calculate an adjustment amount for each tilt assembly. The tilt assembly may then be controlled hydraulically or electrically using outputs from the PLC to automatically adjust the position of its corresponding blade.

In another aspect, the cutting machines 500a and 500b each may comprise a carriage. Each carriage may be controlled by a hydraulic cylinder to move along a guide towards and from the central line C along the direction W, also referred to as horizontal direction. The position of each of the entire cutting machines 500a and 500b can then be moved by the carriage. Therefore, the distance d between the left cutting machine 500a and the right cutting machine 500b may be adjusted. This distance determines the width of the piece cut of the board 505. Different widths of wood cut can be obtained by adjusting the distance d according to requirements.

Changes can be made to the invention in light of the above “Detailed Description” while the above description details certain aspects of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A method for monitoring and controlling a bandsaw blade having a first side, a second side and a cutting edge, comprising steps of:
projecting light on the first side of the bandsaw blade;
capturing at least one image of the second side of the bandsaw blade, the at least one image having a dark area where the light is blocked by the bandsaw blade and a light area where the light is unimpeded;
measuring a position of a boundary line between the light area and the dark area of each image of the least one image; and
determining a position of the cutting edge of the bandsaw blade, while the bandsaw blade is moving, based on the position of the boundary line.

2. The method of claim 1, further comprising: diffusing the light before projecting on the first side of the bandsaw blade.

3. The method of claim 2, further comprising: defining a bounding box before measuring the position of the boundary line, wherein the bounding box has a center location, an upper edge and a lower edge.

4. The method of claim 3, wherein the step of measuring the position of the boundary line comprising measuring a value along a first axis of the center location of the bounding box when the center location of the bounding box aligns with the center of the boundary line.

5. The method of claim 3, wherein the step of measuring the position of the boundary line comprising measuring a value along a first axis of the center location when the upper edge and the lower edge of the bounding box align with an upper edge and a lower edge of the light area of each image respectively.

6. The method of claim 1, further comprising: automatically adjusting the position of the bandsaw blade when the position of the cutting edge of the bandsaw blade deviates from a standard working position to move the blade back towards the standard working position.

7. The method of claim 1, further comprising: determining the oscillation of the bandsaw blade by monitoring the position of the bandsaw blade as the bandsaw blade is moving;
and, providing an indication when the oscillation of the bandsaw blade increases more than an allowable amount.

8. The method of claim 7, further comprising: determining an initial standard deviation of the position of the bandsaw blade determined from a plurality of images as the bandsaw blade is moving; continuing to determine the standard deviation of the position of the bandsaw blade; and, providing an indication when the standard deviation of the position of the bandsaw blade increases more than an allowable among from the initial standard deviation.

9. The method of claim 8, wherein the indication is a warning comprising at least one of: a light; and a sound.

10. A system for monitoring a bandsaw blade having a first side, a second side and a cutting edge, comprising:
a light source projecting light on the first side of the bandsaw blade;
an imaging device with a field of view of the second side of the bandsaw blade and capturing at least one image of the second side of the bandsaw blade; and
a processing unit configured to process each image of the at least one image captured by the imaging device to determine a position of the cutting edge of the bandsaw blade.

11. The system of claim 10, wherein the light source further comprises a light diffusing member on the first side of the bandsaw blade to diffuse the light from the light source.

12. The system of claim, 11 where a first portion of the light diffusing member extends behind the bandsaw blade and a second portion of the light diffusing member extends past the cutting edge of the bandsaw blade, from a point of view of the imaging device.

13. The system of claim 12, wherein the diffusing member is a strip of ultra high molecular weight polyethylene (UHMW) plastic.

14. The system of claim 13, wherein the imaging device is configured to have an exposure time longer relative to the speed of the bandsaw while the bandsaw blade is running to make teeth of the bandsaw blade not visible.

15. The system of claim 10, wherein the processing unit is configured to measure a position of a boundary line between a light area and a dark area of each image to determine the position of the cutting edge of the bandsaw blade.

16. The system of claim 15, wherein a bounding box having a center location, and an upper edge and a lower edge is used to measure the position of the boundary line.

17. The system of claim 16, wherein the position of the cutting edge of the bandsaw blade is determined by measurement of a value along an X coordinate of the center location of the bounding box when the center location of the bounding box aligns with the center of the boundary line.

18. The system of claim 17, wherein the position of the cutting edge of the bandsaw blade is determined by measurement of a value along an X coordinate of the center location of the bounding box when the upper edge and the lower edge of the bounding box align with an upper edge and a lower edge of the light area of each image, respectively.

19. A cutting machine comprising a system according to claim 10, comprising:
a drive wheel;
an idle wheel; the bandsaw blade mounted around the drive wheel and the idle wheel;
a tilt assembly engaging with a shaft of the idle wheel; and
a controller;
wherein the tilt assembly is controlled by the controller for adjusting a position of the bandsaw blade based on the position determined by the system of claim 10.

20. The cutting machine of claim 19, further comprising a console connected with the controller.

21. The cutting machine of claim 20, wherein the console comprises buttons to activate an electric motor to drive the tilt means to cause the shaft of the idle wheel to move.

22. The cutting machine of claim 21, wherein the position of the bandsaw blade is automatically adjusted if the position of the cutting edge deviates from a standard working position.

23. The cutting machine of claim 21, wherein the controller is configured to set out a warning if a standard deviation of the position of the bandsaw blade is increased more than an allowable amount over an initial standard deviation.
